(19) United States
(12) Patent Application Publication
(10) Pub. No.: US 2011/0140888 A1
(43) Pub. Date: Jun. 16, 2011

(54) Printed Article

(75) Inventors: Kate Stone, Cambridgeshire (GB); Mary Blackburn, Cambridgeshite (GB)

(73) Assignee: NOVALIA LTD, Cambridgeshire (GB)

(21) Appl. No.: 12/988,081

(22) PCT Filed: Apr. 9, 2009
(86) PCT No.: PCT/GB09/50350

§ 371 Date: Mar. 1, 2011

(30) Foreign Application Priority Data
Apr. 15, 2008 (GB) 0806804.1

(51) Int. Cl. G08B 21/00

(52) U.S. Cl. 340/540

(57) ABSTRACT

A printed article, such as a greeting card, comprises a substrate formed of card, a sensor for detecting exhaled breath directed at the substrate, the sensor comprising first and second spaced electrodes supported on the substrate, at least one transducer for supplying a user-perceivable signal, such as light emitting diodes, and a switching circuit for causing the at least one transducer to supply the signal in response to detection of exhaled breath.

### FIELD OF THE INVENTION

The present invention relates to a printed article, such as a greeting card or product packaging.

### BACKGROUND

Greeting cards which play music or have flashing lights are known in the art. Theses types of card are provided with a self-contained module. Usually, the module is attached to the back of the card and has a microswitch which is attached, via a connecting strip, to the front of the card such that when the front of the card is opened, the module is activated.

### SUMMARY OF THE INVENTION

According to a first aspect of the present invention there is provided a printed article comprising a substrate, a sensor for detecting exhaled breath directed at the substrate, the sensor comprising first and second spaced electrodes supported on the substrate, means for supplying a user-perceivable signal and switching means for causing the signal supplying means to supply a signal in response to detection of exhaled breath by the sensor.

The electrodes may comprise conductive ink printed on the substrate.

The signal supplying means may include light emitting means, such as at least one light emitting diode, sound emitting means, such as a piezoelectric speaker, and/or vibration emitting means.

The switching means may comprise a microprocessor. The switching means may include a transistor, which may be printed on the substrate.

The printed article may comprise a resistor, wherein the resistor and the sensor are arranged as potential divider. The resistance between the electrodes in the absence of expelled breath may be at least 1 GΩ and the resistor may have a value of resistance of the order of 10 MΩ.

The printed article may further including a battery.

The printed article may be a greeting card. The substrate may comprise paper, card or plastics material.

According to a second aspect of the present invention there is provided a printed article comprising a substrate, a sensor for detecting exhaled breath directed at the substrate, the sensor comprising first and second spaced electrodes supported on the substrate, at least one transducer for supplying a user-perceivable signal and a switching circuit for causing the at least one transducer to supply a signal in response to detection of exhaled breath.

According to a third aspect of the present invention there is provided a method of fabricating a printed article, the method comprising printing first and second spaced electrodes on a substrate so as to provide a sensor for detecting exhaled breath directed at the substrate, mounting, to the substrate, means for supplying a user-perceivable signal and providing switching means for causing the signal supplying means to supply a signal in response to detection of exhaled breath.

According to a fourth aspect of the present invention there is provided a method of using the printed article, the method comprising blowing onto the substrate.

### BRIEF DESCRIPTION OF THE DRAWINGS

Embodiments of the present invention will now be described, by way of example, with reference to the accompanying drawings, in which:

FIG. 1 is a perspective view of a greeting card in accordance with the present invention;

FIG. 2 is magnified plan view of a sensor comprising first and second spaced electrodes;

FIG. 3 is circuit diagram for detecting exhaled breath by the sensor;

FIG. 3a illustrates an alternative switching means; and

FIGS. 4a and 4b illustrate using the greeting card.

### DETAILED DESCRIPTION OF EMBODIMENTS

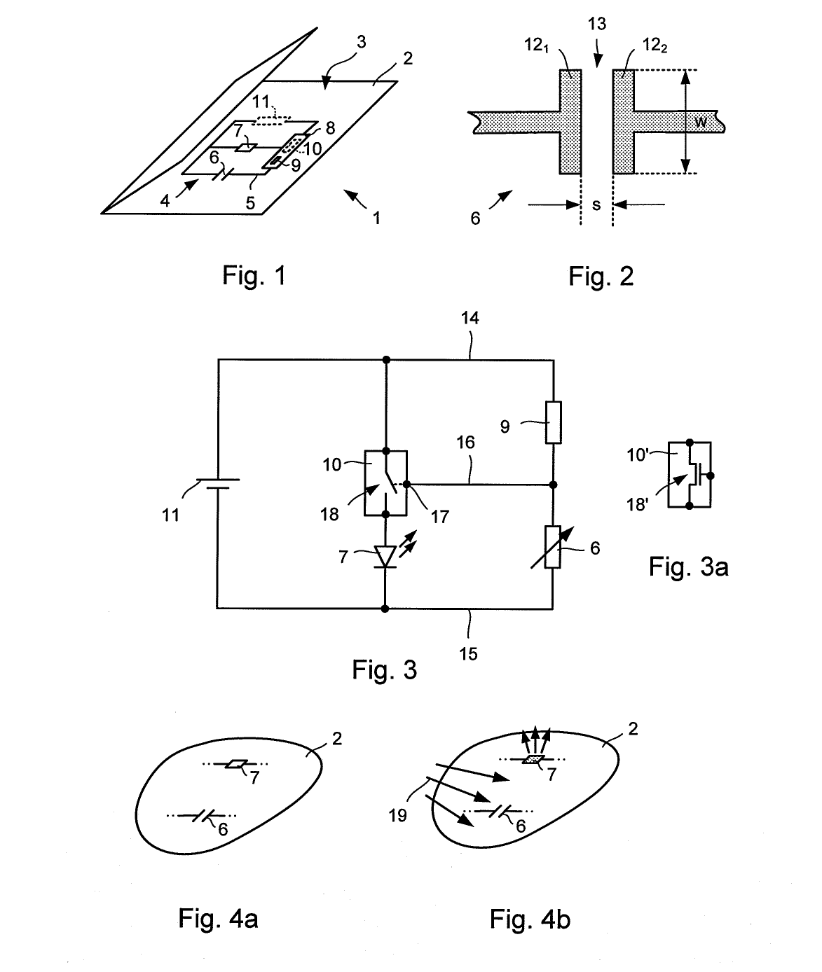

Referring to FIG. 1, a greeting card 1 in accordance with the present invention is shown. The greeting card 1 has a substrate 2 formed of card and a face 3 for displaying to a user. The face 3 of the card 2 includes text and/or graphics (not shown).

At least part of a circuit 4 is formed on the face 3 of the card 2 and includes tracks 5 formed of silver-based conductive ink. Suitable conductive inks are available from Sun Chemical Corporation, Parsippany, N.J., USA. The tracks 5 can be printed using a printing process, such as screen printing or ink jet printing.

The circuit 4 includes a sensor 6 for detecting exhaled breath directed at the substrate 2 and one or more light emitting diodes 7 or other output devices. The light emitting diodes 7 can be attached directly onto the card 2 using conductive glue or ink. The circuit 4 includes a portion 8 which includes a pull-up resistor 9 and a processor 10.

In this example, the circuit portion 8 is formed on a circuit board (not shown) and is glued to a reverse face (now shown) of the card 2 or to another card, so as to be sandwiched between the cards. However, the circuit portion 8 can be formed directly, e.g. printed, on the substrate 2. A battery 11 is used to provide power to the circuit 4, for example in the form of a thin lithium polymer battery.

Referring to FIG. 2, the sensor 6 includes first and second spaced electrodes 12₁, 12₂ printed on the card 2. The electrodes 12₁, 12₂ are formed from a silver-based conductive ink. However, other forms of conductive ink can be used. The electrodes 6 are separated by a gap 13. The gap 13 can be bridged by finger contact and a connection can be made between the electrodes 12₁, 12₂. Under usual ambient conditions, i.e. when the user is not breathing on the sensor 6, the resistance between the electrodes 12₁, 12₂ is at least of the order 1 GΩ. When the user exhales onto the sensor 6, the resistance drops to about 4 MΩ or so. Thus, the sensor 3 behaves a variable resistor having high and low values.

As shown in FIG. 2, the gap 13 has a length, s, of about 1 to 3 mm and the electrodes 12₁, 12₂ have a width, w, of about 1 cm. The electrodes 12₁, 12₂ have a parallel-plate arrangement. Other electrode arrangements may be used. The electrodes 12₁, 12₂ need not be straight, but can be curved or may have interdigitated arrangement.

Referring to FIG. 3, the circuit 4 is shown in more detail. The sensor 6 and resistor 9 are arranged a potential divider between a supply and ground rails 14, 15. The supply rail 14 is about 3V. A tap 16 between the sensor 6 and resistor 9 is fed, via input 17, into a microcontroller 10, for example a PIC(RTM) microcontroller available from Microchip Technology Inc., Chandler, Ariz., USA.

In the absence of moisture, the input 17 to the processor 10 is close to the supply voltage. Thus, as shown in FIG. 4a, the light emitting diode 7 is not activated.

In the presence of moisture, the input 17 is pulled towards the ground rail 15. The processor 10 detects that the input 17 has passed a threshold voltage, Vₜₕ, closes a switch 18 and causes current to flow through the light emitting diode 7. Thus, as shown in FIG. 4b, when a user exhales their breath 19 onto the sensor 6, the light emitting diode 7 is activated.

To achieve this operation, the pull up resistor 9 has a value of about 68 MΩ. However, a resistor having a value of between 40 to 100 MΩ can be used, for example 82 MΩ. However, the value of the pull up resistor 9 and the resistance of the sensor 6 can be found through routine experiment, e.g. by using pull up resistors of different values, checking that the light emitting diode 7 is off under ambient conditions, blowing on the card 2 and checking that the light emitting diode 7 turns on. Typically, the pull-up resistor 8 has a value of the order of 10 MΩ, about 10 times larger than the value of the sensor 6 when it is in a low resistive state.

The processor 10 can be used to control more than one light emitting diode, or other output device, either collectively, e.g. by connecting the light emitting diode in series, or independently via separate lines. The processor 10 can be programmed to activate the light emitting diodes in a predetermined pattern, e.g. to flash on and off, and to continue to operate the light emitting diodes after the user has ceased blowing onto the sensor 6. Thus, the processor 10 can be used to provide effects, such as candles flickering and/or playing a tune.

Referring to FIG. 3a, a simpler arrangement can be used in which the processor 10 is replaced by another controlling means 10′ comprising switching means in the form of a transistor 18′. The transistor 18 can be printed directly onto the card 2 (FIG. 1) and may take the form of an organic field effect transistor.

It will be appreciated that many modifications may be made to the embodiments hereinbefore described. For example, other forms of audio/visual output devices may be used, such as thermochromic displays and buzzers. The resistor 9 (FIG. 1) can be printed on the substrate. The tracks 5 (FIG. 1) may be formed from foil. The printed article need not be a greeting card, but may be postcard, poster, packaging for a product, board game or in-store display. The printed article can be formed from paper, card, cardboard or plastic. The tracks may be covered by other layers of ink providing text or graphics.

1. A printed article comprising:
a substrate;
a sensor for detecting exhaled breath directed at the substrate, the sensor comprising first and second spaced electrodes supported on the substrate;
at least one transducer for supplying a user-perceivable signal; and
a switching circuit for causing the at least one transducer to supply the signal in response to detection of exhaled breath.

2. A printed article according to claim 1, wherein the electrodes comprise conductive ink printed on the substrate.

3. A printed article according to claim 1, wherein the at least one transducer includes light emitting means.

4. A printed article according to claim 3, wherein the light emitting means comprises at least one light emitting diode.

5. A printed article according to claim 1, wherein the at least one transducer includes sound emitting means.

6. A printed article according to claim 1, wherein the at least one transducer includes vibration emitting means.

7. A printed article according to claim 1, wherein the switching circuit comprises a microprocessor.

8. A printed article according to claim 1, wherein the switching circuit includes a transistor.

9. A printed article according to claim 8, wherein the transistor is printed on the substrate.

10. A printed article according to claim 1, further comprising a resistor, wherein the resistor and the sensor are arranged as a potential divider.

11. A printed article according to claim 10, wherein the resistance between the electrodes in the absence of expelled breath is at least 1 GΩ and the resistor has a value of resistance of the order of 10 MΩ.

12. A printed article according to claim 1, further including a battery.

13. A printed article according to claim 1, which is a greeting card.

14. A printed article according to claim 1, wherein the substrate comprises paper or card.

15. A printed article according to claim 1, wherein the substrate comprises a plastics material.

16. (canceled)

17. A method of fabricating a printed article, the method comprising:
printing first and second spaced electrodes on a substrate so as to provide a sensor for detecting exhaled breath directed at the substrate;
mounting, to the substrate, at least one transducer for supplying a user-perceivable signal; and
providing a switching circuit for causing the at least one transducer to supply the signal in response to detection of exhaled breath.

18. A method of using a printed article, comprising:
a substrate.,
a sensor for detecting exhaled breath directed at the substrate, the sensor comprising first and second spaced electrodes supported on the substrate;
at least one transducer for supplying a user-perceivable signal; and
a switching circuit for causing the signal supplying means to supply a signal in response to detection of exhaled breath;
the method comprising:
blowing onto the substrate.
